(19) United States
(12) Patent Application Publication
(10) Pub. No.: US 2002/0157487 A1
(43) Pub. Date: Oct. 31, 2002

(54) Actuator assembly

(76) Inventor: Mehdi A. Imani, Minneapolis, MN (US)

Correspondence Address: NAWROCKI, ROONEY & SIVERTSON, P.A., Broadway Place East, Suite 401, 3433 Broadway Street N.E., Minneapolis, MN, 55413, US

(21) Appl. No.: 10/074,878

(22) Filed: Feb. 12, 2002

Related U.S. Application Data
(60) Provisional application No. 60/268,160, filed on Feb. 12, 2001.

(51) Int. Cl. G01D 21/00

(52) U.S. Cl. 73/866.5

(57) ABSTRACT

The present invention provides an actuator assembly for uniformly actuating a testing device into a test socket assembly. The actuator assembly has a guide member for interlocking the actuator assembly with the test socket assembly. Once the actuator assembly is interlocked, a stem having a planar contact surface is able to uniformly engage a test device and actuate the test device into the test socket. The present invention further provides a mechanical stop for locking the actuated stem for multiple testing.

### CROSS REFERENCE TO RELATED APPLICATIONS

This is a regular application filed under 35 U.S.C. § 111(a) claiming priority, under 35 U.S.C. § 119(e) (1), of provisional application Serial No. 60/268,160, previously filed Feb. 12, 2001 under 35 U.S.C. § 111(b).

### 1. FIELD OF THE INVENTION

The present invention relates to the field of testing devices. More specifically, the present invention relates to an actuator for use in testing of integrated circuits.

### 2. BACKGROUND OF THE INVENTION

An actuator is used to actuate or compress a testing device into a test socket. A test device, such as an integrated circuit, generally has a plurality of leads extending from the test device. The leads of the test device are tested by placing the test device in a test socket. It is important that the leads of the test device are properly engaged with the corresponding contacts within the test socket. An actuator is used to compress the test device into the test socket to ensure that there is sufficient contact between the leads of the test device and the contacts of the test socket.

One type of actuator commonly employed in the art is a hinged assembly that closes over the test device in the test socket. The test socket is located in a contactor housing assembly. The actuator is opened at its hinge to allow the test device to be received within the test socket. The actuator is then closed over the test device and a latch is used to maintain the tst device into the test socket in a closed configuration.

Another type of actuator commonly used is the double latch actuator. The double latch actuator operates similar to the hinged actuator in that it requires the actuator to be latched to the test socket assembly. As a practical matter, a first side of the actuator will be latched before the second side is latched.

One problem with the actuators described above is the size of the test socket assembly that is required. For example, the hinged actuator requires a frame to be secured to the housing such that the hinged portion of the actuator is able to pivot about the housing and maintain proper positioning when actuating the test device. Because the frame of the actuator must be attached to the test socket assembly, the test socket assembly must have a much greater periphery than needed to merely house the test socket. The double latched actuator has similar restraints where it requires the test socket assembly to have a periphery capable of engaging the respective latches of the actuator assembly.

Another problem with current actuator assemblies is the lack of adaptability to different size test devices. Test devices can have various dimensions. An actuator that adequately compresses a first test device may be inadequate for a test device with different dimensions. For example, for a single actuator assembly a thin test device may not be sufficiently compressed into the test socket whereas a thick test device may be overly compressed into the test socket.

Another problem with current actuators is that they do not uniformly compress the test device into the test socket. Because the actuator is hinged or double latched, the actuator will tend to contact the test device non-uniformly. With a hinged actuator, for example, the actuator will tend to contact one portion of the test device as it is closed over the test device. The portion of the actuator nearest the hinge will tend to be contacted by the test device before the portions of the actuator that are a greater distance from the hinge. In the double latched actuator, the first side that is latched will tend to contact a portion of the test device with a non-uniform force until the second latch is latched. This results in a non-uniform compression or actuation, which may damage the test device and/or affect the testing of the test device.

### SUMMARY OF INVENTION

The present invention provides an actuator assembly capable of uniformly contacting and actuating a test device into a test socket. The invention utilizes a guide member that is positioned over the test device by interlocking the guide member with the test socket assembly. A stem is moveably positioned within a through-hole of the guide member. The stem has a planar contact surface for contacting the test device. As the stem is advanced toward the test device it uniformly compresses the test device into the test socket. The stem is urged toward the test device by an actuator. As the stem contacts the test device, the actuator can be locked into place by a mechanical stop, such that the actuator maintains uniform pressure on the test device during testing.

In a first embodiment of the present invention, the guide member is interlocked to the test socket housing by receiving a pair of alignment screws into a receiving slot in the base of the guide member. Once the pair of alignment screws is received within the guide member, the guide member is rotated such that the screws lock the guide member over the test device.

A second embodiment of the present invention illustrates an interlocking mechanism wherein the alignment screws are partially exposed from within the guide member walls when interlocked within the guide member.

A third embodiment of the present invention illustrates an actuator with a winged guide member. The wings extend on opposite sides of the guide member and have a top portion that can be pinched together such that the first wing progresses toward the second wing. The wings have a bottom portion that acts as an interlocking member wherein as the top portion of the wings are pinched together the bottom portion of the first wing separates from the bottom portion of the second wing. The interlocking members are received within a corresponding relief area in the test socket assembly. As the wings are pinched, the bottom portions are aligned with the corresponding relief area. Once aligned, the pinching force is removed from the wings such that the interlocking members of each angle wing are received within the relief area of the test socket assembly.

The current invention allows the actuator to be aligned over the test device so as to allow a uniform contact pressure with the surface of the test device during actuation. Additionally, the size of the test socket assembly, which can include the alignment plate positioned over the test socket, need only be capable of interlocking with the actuator assembly.

### BRIEF DESCRIPTION OF THE DRAWINGS

FIG. 1A is an exploded perspective view of the preferred embodiment of the invention;

FIG. 1B is an exploded perspective view of the preferred embodiment of the invention taken from a different angle;

FIG. 2A is a top plan view of an alternate embodiment of the invention;

FIG. 2B is a section thereof taken along line 2B-2B in FIG. 2A and rotated 90 degrees CCW;

FIG. 2C is a fragmentary perspective view thereof;

FIG. 3A is a perspective view of a second alternate embodiment of the invention;

FIG. 3B is an exploded view thereof, and;

FIG. 3C is an enlarged fragmentary detail thereof at the bottom of FIG. 3B.

### DETAILED DESCRIPTION OF PREFERRED EMBODIMENTS

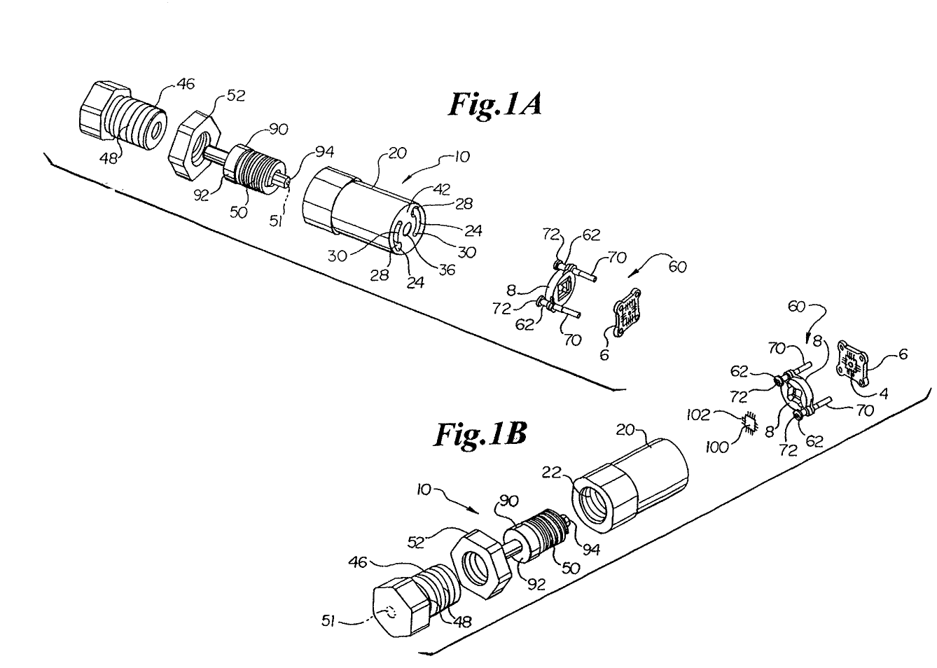

FIGS. 1A, 1B and 1C illustrate an embodiment of the present invention. In this embodiment, the actuator assembly 10 comprises a guide member 20 for guiding the stem 90 towards the test device 100. A through-hole 22 extends along the length of the guide member 20. A stem 90 is moveably positioned within the guide member 20 wherein the stem 90 can be urged within the through-hole 22 towards the test device 100. The stem 90 is urged toward the test device 100 by a contact force from the actuator 46. As the actuator 46 is urged toward the stem 90, the actuator 46 will contact the stem 90 and urge the stem 90 toward the test device 100. The force applied to the actuator 46 may be a manual force or an automated force. The stem 90 has a planar contact surface 94 for engaging contact with the test device 100. The contact surface 94 allows the stem 90 to uniformly contact the test device 100.

The test device 100 illustrated in FIG. 1B is an integrated circuit. The test device 100 has a plurality of leads 102 extending from its structure. The test device 100 is received within a test socket assembly 60. The test socket assembly 60 comprises a test socket 4, a housing 6, and an alignment plate 8. The test socket 4 has a plurality of contacts that correspond to the plurality of leads 102 on the test device. The contacts are positioned in the housing 6 of the test socket assembly. The alignment plate 8 is positioned over the top of the housing 6. The alignment plate 8 assists in the proper alignment of the test device 100 over the test socket 4. The test device 100 is properly aligned with the test socket assembly 60 where each of the plurality of leads 102 of the test device is aligned with a corresponding contact in the test socket 4.

Once the test device 100 is positioned within the test socket assembly 60, the actuator 46 is utilized to effect contact between the leads 102 of the test device and the contacts of the test socket assembly by uniformly urging the test device 100 into the test socket 4. The contact surface 94 of the stem 90 is capable of uniformly engaging the test device 100 and urging the test device 100 into the test socket assembly 60. Actuation occurs where the stem 90 contacts and urges the test device 100 into the test socket 4. The actuation effects a uniform engagement of the leads 102 of the test device with the contacts of the test socket assembly. Where the test device 100 has a plurality of leads 102, the uniform actuation minimizes the possibility that a portion of the leads will undergo a disproportionate amount of actuation force with respect to another portion of the leads.

During actuation, the stem 90 and actuator 46 advance toward the test device 100. Once the actuation occurs, the position of the stem 90 and actuator 46 with respect to the guide member 20 can be fixed by a mechanical stop 52. FIGS. 1A and 1B illustrate a mechanical stop 52 comprising a threaded actuator 46 and an adjustable nut 52. The actuator has a threaded portion 48, like that of an adjustable screw. The adjustable nut 52 is positioned on the top portion of the guide member 20. As the actuator 46 is advanced toward the test device 100, the threaded portion 48 is received within the adjustable nut 52. The actuator 46 may then be locked into a predetermined position by adjusting the threaded portion 48 of the actuator within the adjustable nut 52. The actuation of the test device 100 may then be maintained for repeat testing of the test device 100, and/or for an extended period of time.

The actuator assembly 10 is positioned over the test device 100 by interlocking the base 42 of the guide member with the test socket assembly 60. The guide member 20 illustrates a guide member having a slotted base 42. The slotted base 42 acts as the interlocking portion of the guide member. The slotted base 42 has a central through-hole 36 having a common axis with the through-hole 22 of the guide member. The central through-hole 36 of the slotted base has a lesser diameter than the through-hole of the guide member. The slotted base has a pair of slots 24 radially spaced from the central axis. Each slot has a wide portion 28 and a narrow portion 30, wherein the wide portion 28 acts as a receiving portion and the narrow portion 30 acts as a locking portion. The slots 24 illustrated in FIG. 1 have a curvature about the axis of the central through hole.

The test socket assembly 60 illustrated in FIGS. 1A and 1B includes a pair of double head screws 62 extending upwardly from the test socket assembly 60. Each double head screw has a head 72 and an elongate portion 70, the head being wider than the elongate portion. The actuator assembly 10 is interlocked with the test socket assembly 60 by, first, receiving the head 72 of a screw into the wide portion of a corresponding slot 28 such that the bottom portion of the head extends above the top portion of the slotted base, and, second, rotating the guide member about the axis such that the head 72 is positioned on the top portion of the slotted base and over the narrow portion of the corresponding slot.

A compression spring 50 is located within the guide member through-hole 22 in assembly. The stem 90 has a center portion 92 that is wider than the contact portion 94 of the stem. The spring 50 is positioned between the wide portion of the stem and the top portion of the guide member base. Thus, when the actuator assembly 10 is actuated, the spring 50 is compressed. When the mechanical stop 52 is removed from the locked position, the compression spring 50 will expand to remove and/or decrease the amount of downward force exerted by the stem 90 on the test device 100. The spring 50 may be of conductive or non-conductive material. Alternatively, the spring may be an elastomer tube, or any such structure that would perform the function of removing the actuating contact between the stem and test device.

The test socket assembly 60 may be connected to a load board for testing of the test device. The housing 6 and/or the alignment plate 8 and/or the test socket 4 may be interchanged for use with different test devices. Different test devices may have different dimensions. Where the stem 90 advances a predetermined distance for a given test device 100, the distance that the stem must be advanced may vary for test devices having different dimensions. The mechanical stop 52 may be adjusted to compensate for different test device dimensions such that the actuator assembly 10 described herein is capable of performing with a multiplicity of test devices and/or test device dimensions.

The double head screws 72 may be used to secure the test socket assembly together. It is understood that the structure of the double head screw affects the function of the embodiment illustrated in FIGS. 1A and 1B. The composition of the double head screw is not critical. For example, the double head screw may be conductive or non-conductive material, threaded or unthreaded, so long as it provides the structure is sufficient to provide the interlocking function with the base 42. The structure and dimensions of the test socket assembly and base, in this and the other embodiments disclosed herein, need only be sufficient to provide the interlocking function between the actuator assembly and the test socket assembly.

The stem 90 may additionally have a vacuum cap 49 wherein, as a vacuum is applied to the cap 49 through an orifice 51 in actuator 46 and stem 90, the test device 100 can be removed from the test socket 4 while maintaining contact with the stem 90.

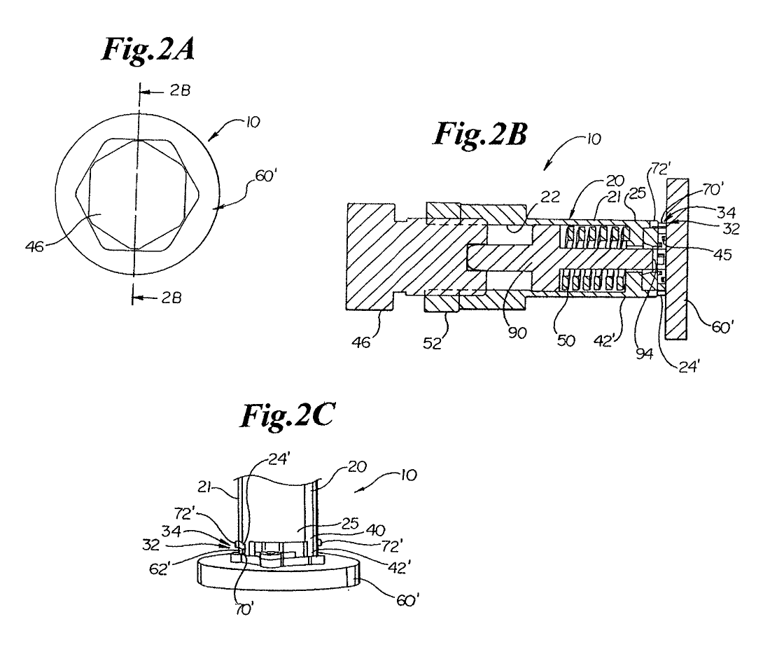

FIGS. 2A, 2B and 2C illustrate an alternative embodiment of the present invention. The embodiment in FIGS. 2A, 2B and 2C is similar to that illustrated in FIGS. 1A and 1B with the exception of the interlocking portions of the actuator assembly 42 and test socket assembly 60. In this embodiment, the base 40 of the guide member 20 acts as an interlocking portion by providing an exposed slotted base 42′. The base 42′ has a central though-hole 22, as in FIGS. 1A and 1B. In FIGS. 2A and 2B, at least a portion of the radially spaced slots 24′ are aligned beneath the guide member wall 25. This is in contrast to FIG. 1A where the slots 24′ are aligned beneath the guide member 20 arcuate to through-hole 36. The result is that a portion of the slots 24′ in FIGS. 2A and 2C are exposed externally to the guide member outer wall 21. The exposed slots 24′ have a receiving portion 32 and a locking portion 34. The receiving portion 32 extends vertically into the wall of the base 42, and the locking portion 34 extends perpendicular to the receiving portion 32 at a height above the bottom of the base 60′.

FIG. 2B illustrates the interlocking portion 34 of the test socket assembly 60′ as a pair of dowel pins 62′. The dowel pins 62′ have a heads 72′ and elongate portions 70′ extending therefrom. The heads 72′ have a greater diameter than the elongate portions 70′. The heads 72′ of the dowel pins 62′ are received within corresponding receiving portions 32 of the base 42′. The heads 72′ are exposed such that at least a portion of the heads 72′ are visible from the guide member outer wall 21. Once a head 72′ is sufficiently advanced into the receiving portion 32, the guide member 20 is rotated such that the corresponding head 72′ is positioned in the locking portion 34 of the base 42′. At least a portion of the head 72′ is likewise exposed when positioned in the interlocking portion 34 of the base.

The guide member 20 illustrated in FIGS. 2A and 2B needs to have dimensions sufficient to receive a dowel pin head 72′ in a corresponding exposed slot 24′. Because a portion of the slot 24′ extends to the external wall 21 of the guide member 20, the width of the guide member 20 illustrated in FIGS. 2B and 2C may be less than that illustrated in FIGS. 1A, 1B and 1C.

The dowel pins 62′ illustrated in FIG. 2C may be conductive or non-conductive material, so long as the dowel pins 62′ have a structure capable of interlocking with the actuator assembly 42′. Additionally, the actual shape and structure of the guide member 20 need only be sufficient for interlocking with the test socket assembly 60 and are not limited to the structures illustrated in FIGS. 1A through 2C.

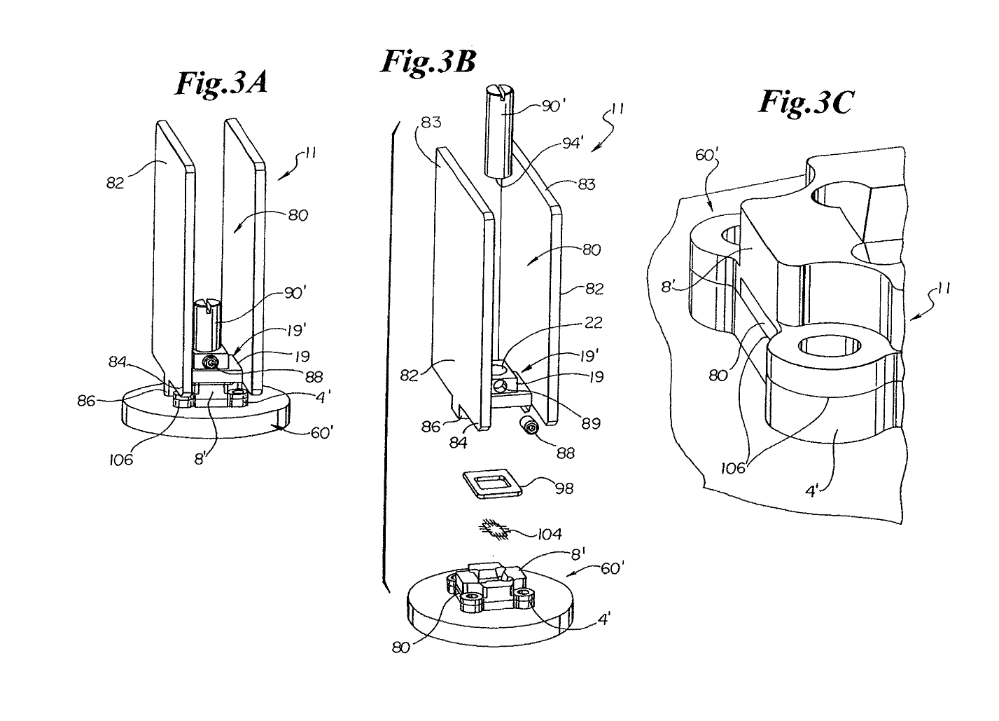

FIGS. 3A, 3B and 3C illustrate yet another embodiment of the present invention. In this embodiment, the actuator assembly 11 has a pair of wings 82, each having an interlocking portion 86 that is received within a relief area 80 in the test socket assembly 60′.

The guide member 19 illustrated in FIGS. 3A and 3C has a through-hole 22 extending along the entire length of the guide member. The stem 90′ is illustrated as a single solid member. The guide member 19 has an aperture 89 in a portion of the wall for receiving a set-screw 88. The aperture 89 is perpendicular to the axis of the through-hole 22. The set-screw 88 acts as a mechanical stop and is used to lock the position of the stem 90′ within the guide member 19. The position of the stem 90′ is adjustable with the set screw 88 and may be adjusted according to the dimensions of the test device 100 and test socket assembly 60′.

The actuator assembly 11 in FIGS. 3A, 3B and 3C has a pair of wings 82′ or winged structures positioned on opposite sides of the guide member 19. The guide member 19 is positioned substantially toward a lower portion 84 of the wings 82. Each wing 82 has a bottom portion 84 having an interlocking member 86 for engaging the test socket assembly 60′. The interlocking members 86 extend such that the interlocking member 86 of each wing 82 extends a determined distance toward the opposing wing 82.

The test socket assembly 60′ has an interface 104 between the alignment plate and the housing. A relief area 80 is located at the interface 106 on opposite sides of the test socket assembly 60′. The relief area 80 acts as an interlocking portion of the test socket assembly 60′ by receiving the interlocking members 86 of the actuator assembly 11.

The upper portion 83 of each of the wings 82 may be pinched together such that the upper portion 83 of the wings 82 are urged toward each other. This causes the interlocking members 86 to move away from each other. This pinching allows the interlocking members 86 to be positioned to enter the corresponding relief area 80 of the test socket assembly 60′. Once the interlocking members 86 are positioned to be received into the relief area 80, the upper portion 83 of a wing 82 may be allowed to separate thus causing the interlocking members 86 to be received within the corresponding relief areas 80.

Once the actuator assembly 11 is properly interlocked with the test socket assembly 60′, the actuator assembly 11 is capable of uniformly urging the test device into the test socket. The contact portion 94′ of the stem 90′ is able to uniformly actuate the test device 100 into the test socket 4.

As illustrated in FIGS. 3A, 3B and 3C, a compression elastomer 98 may be positioned between the lower portion of the actuator alignment structure 19′ and the alignment plate 8′.

It will be understood that this disclosure, in many respects, is only illustrative. Changes may be made in details, particularly in matters of shape, size, material, and arrangement of parts without exceeding the scope of the invention. Accordingly, the scope of the invention is as defined in the language of the appended claims.

1. An actuator assembly comprising:
a guide member having an interlocking portion for positioning said guide member over a test device, said guide member having a through-hole and an interlocking portion, and
a stem being moveably positioned within said through-hole, said stem having a planar contact surface for uniformly engaging the test device, and
a mechanical stop for locking a position of said stem within said through-hole and maintaining said stem in contact with the test device.

2. The actuator assembly according to claim 1, wherein said interlocking portion of said guide member comprises a slotted base.

3. The actuator assembly according to claim 2, wherein said actuator assembly has an actuator for contacting said stem and urging said stem toward the test device.

4. The actuator assembly according to claim 31, wherein said actuator has a threaded portion.

5. The actuator assembly according to claim 4, wherein said mechanical stop comprises an adjustable nut having an inner portion capable of receiving said threaded portion of said actuator.

6. The actuator assembly according to claim 2, wherein said slotted base has at least a single slot having a receiving portion and a locking portion for receiving a corresponding interlocking member.

7. The actuator assembly according to claim 6, wherein said corresponding interlocking member is a set screw.

8. The actuator assembly according to claim 6, wherein said corresponding interlocking member is a dowel pin.

9. The actuator assembly according to claim 6, wherein said corresponding interlocking member comprises a non-conductive material.

10. The actuator assembly according to claim 2, wherein said actuator assembly has a pair of slots for receiving an interlocking member within each of said pair of slots.

11. The actuator assembly according to claim 6, wherein said corresponding interlocking member extends from a test socket assembly.

12. The actuator assembly according to claim 2, wherein a compression spring is positioned within said guide member, said compression spring having a first end contacting said slotted base and a second end contacting a portion of said stem.

13. The actuator assembly according to claim 12, wherein said compression spring comprises a non-conductive material.

14. The actuator assembly according to claim 12, wherein said compression spring comprises an elastomer tube.

15. The actuator assembly according to claim 11, wherein said stem has a vacuum cap wherein as a vacuum is applied to said vacuum cap, the test device is removed from said test socket assembly.

16. The actuator assembly according to claim 1, wherein said interlocking portion of said guide member is an exposed slot base.

17. The actuator assembly according to claim 16, wherein said exposed slot base has a plurality of slots for receiving a corresponding interlocking member.

18. The actuator assembly according to claim 17, wherein each of said plurality of slots have a receiving portion at a bottom portion of said exposed slot base and a locking portion extending perpendicular to said receiving portion.

19. The actuator assembly according to claim 18, wherein as said locking portion receives said corresponding interlocking member, a portion of said corresponding interlocking member is visually exposed from an outer wall of said guide member.

20. The actuator assembly according to claim 17, wherein said corresponding interlocking member is comprises a conductive material.

21. The actuator assembly according to claim 17, wherein said corresponding interlocking member comprises a non-conductive material.

22. The actuator assembly according to claim 17, wherein said exposed slot base has a pair of slots for receiving a corresponding interlocking member.

23. The actuator assembly according to claim 1, wherein said interlocking portion has a pair of wings wherein each of said pair of wings has an interlocking member at a lower engaging portion of each of said pair of wings.

24. The actuator assembly according to claim 23, wherein each of said pair of wings has an upper portion wherein as upper portion of said pair of wings is pinched together said lower engaging portion separates.

25. The actuator assembly according to claim 24, wherein said actuator assembly is interconnected to a test socket assembly by urging said engaging portion of said pair of wings into a receiving portion of said test socket assembly.

26. The actuator assembly according to claim 23, wherein said mechanical stop is a set-screw.

27. The actuator assembly according to claim 26, wherein said set-screw locks said stem by engaging said stem from a set-screw hole positioned within said guide member perpendicular to the direction of said through-hole.

28. An actuator for setting and maintaining a predetermined compression on a test device during testing, said actuator comprising:
a stem having a first end for contacting the test device, and a second end,
an actuator for contacting said second end of said stem, thereby advancing said stem toward the test device, and
an adjustable stop for contacting a portion of said actuator, said adjustable stop constructed and arranged to limit the advancement of said stem with respect to the test device.

29. A method for uniformly actuating a test device into a test socket comprising the steps of:
1) positioning an actuator assembly over said test device wherein said test device is positioned within a test socket assembly, and
2) interlocking said actuator assembly with said test socket assembly, and
3) actuating said actuator assembly wherein a contacting portion of said actuator assembly urges said test device into said test socket assembly, and
4) locking said actuator assembly such that said contacting portion maintains actuation contact with said test device.
